(19) United States
(12) Patent Application Publication
(10) Pub. No.: US 2004/0058105 A1
(43) Pub. Date: Mar. 25, 2004

(54) 100% nylon fabric garment protector

(76) Inventor: Anna Leta Manning Porter, Sun City Center, FL (US)

Correspondence Address: Anna L. Manning Porter, G. B. K. Enterprise, 1610 West Del Webb Blvd, Sun City Center, FL, 33573, US

(21) Appl. No.: 10/192,879

(22) Filed: Sep. 19, 2002

(51) Int. Cl. B32B 1/02

(52) U.S. Cl. 428/35.7

(57) ABSTRACT

The 100% Nylon Fabric Garment Protector is made from a sheer 100% Nylon Fabric. It was designed to replace the old plastic dry cleaner bag, an other Plastic Bags. Plastic does not breathe, so the Cleaning Chemicals and Odor can not disappear, but can go into the fabric of the clothes. Bags made from plastic and Heavy Materials do not wick the moisture in the air quickly. This can create that musty odor you can smell some time in your clothes, when you first take them out of the closet. The Nylon Fabric Garment Protector is washable, re-useable, your closet looks neat, and your clothes are protected from dust. Made in the USA.

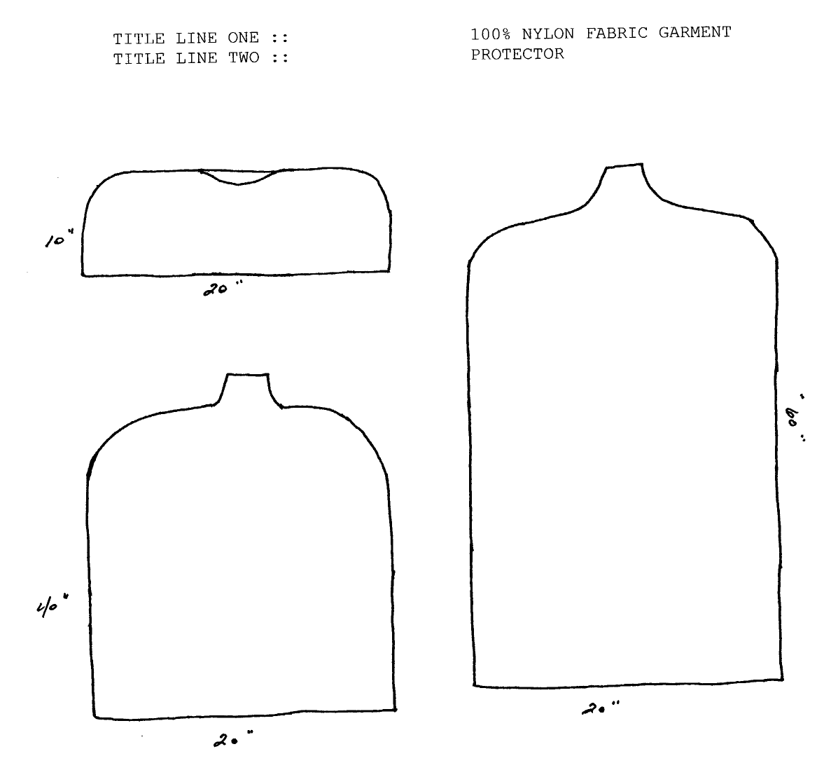

### CROSS-REFERENCE TO RELATED APPLICATIONS

Provisional Patent Application Number 60/300,718 Filing Date Jun. 26, 2001, Atty docket No D-01M/01

### BACKGROUND OF THE INVENTION

The 100% Nylon Fabric Garment Protector is designed to replace the old plastic dry cleaner bag. Plastic does not breathe, and allow the Cleaning Chemicals used to disappear, so the Odor goes into the garment. You can also have moisture build-up inside, between the plastic bag and the garment.

The 100% Nylon Fabric Garment Protector will eliminate that problem.

### BRIEF SUMMARY OF THE INVENTION

The 100% nylon Fabric Garment Protector was designed to cover your clothes in the closet, allow the fabric of the garment to breathe, eliminate moisture build-up, protect them from dust, help reduce color fading, it is washable, and you can see through it.

1. What I claim as my invention is the 100% nylon fabric garment Protector.

2. It is designed to cover your clothes in the closet an—
let the garment's fabric breathe.

3. Covering your clothes with a garment bag made from plastic, or some other plastic/heavy material combination does not give the same protection.

4. Plastic does not breathe,—
heavy materials do not wick the moisture in the air quickly,—
this can create that musty odor you can smell some time in your clothes, when you take them out of the closet to put them on.
